(19) United States
(12) Patent Application Publication
(10) Pub. No.: US 2007/0261664 A1
(43) Pub. Date: Nov. 15, 2007

(54) Internal combustion engine with direct fuel injection

(76) Inventors: Frank Altenschmidt, Biberach (DE); Dietmar Bertsch, Aspach (DE); Michael Dohn, Vaihingen (DE); Uwe Schaupp, Wernau (DE); Dirk Voigtlander, Korntal-Munchingen (DE)

Correspondence Address: KLAUS J. BACH, 4407 TWIN OAKS DRIVE, MURRYSVILLE, PA, 15668, US

(21) Appl. No.: 11/800,004

(22) Filed: May 1, 2007

Related U.S. Application Data
(63) Continuation-in-part of application No. PCT/EP05/11274, filed on Oct. 20, 2005.

(30) Foreign Application Priority Data
Nov. 3, 2004 (DE) 10 2004 053 051.3

(51) Int. Cl. F02B 3/00; F02B 5/00

(52) U.S. Cl. 123/298; 123/305

(57) ABSTRACT

In an internal combustion engine comprising at least one cylinder including a combustion chamber formed between a piston and a cylinder head including inlet and exhaust ports, an outwardly opening injection nozzle for injecting fuel in the form of a hollow cone into the combustion chamber and a spark plug mounted in the cylinder head, the spark plug is positioned at a distance B from the exhaust port axis and the cylinder bore having a diameter D such that the ratio B/D is between 0.02 and 0.13, in particular between 0.04 and 0.1.

This is a Continuation-In-Part Application of pending International Patent Application PCT/EP2005/011274 filed Oct. 20, 2005 and claiming the priority of German Patent Application 10 2004 053 051.3 filed Nov. 3, 2004.

### BACKGROUND OF THE INVENTION

The invention relates to a spark ignition internal combustion engine with direct fuel injection including a cylinder with a combustion chamber formed therein between a cylinder head and a piston and inlet and outlet ports formed in the cylinder head and a fuel injector and a spark plug mounted in the cylinder head.

In the operation of spark ignition internal combustion engines with direct fuel injection, injection nozzles are used which are intended to ensure improved combustion with low emissions by the formation of a particular fuel jet shape. Especially with a jet-guided combustion process, outwardly-opening injection nozzles are used for shaping an optimized injection of fuel.

An internal combustion engine in which the fuel is introduced into the combustion chamber in the form of a hollow cone by an outwardly-opening injection nozzle is known from DE 199 11 023 C2. In a stratified-charge mode the fuel impinges on compressed combustion air in the combustion chamber, so that an edge swirl is thereby formed in the combustion chamber. An ignitable fuel/air mixture is thus transported into proximity to a spark plug. The spark plug is arranged in such a way that the electrodes of the spark plug project into the edge swirl produced, while being located outside a lateral surface of the hollow fuel cone formed during injection of the fuel.

The arrangement of the injection nozzle in the combustion chamber and the positioning of a spark plug provided for igniting a fuel/air mixture formed are of decisive importance for the combustion properties of the internal combustion engine and for its efficiency. To achieve reliable ignition, the configuration of the combustion chamber is decisive in preventing the occurrence of misfiring during operation. Misfiring is often explained by the fact that fuel jet shaping elements with slight deviations from an ideal jet structure are often produced during manufacture of the injection nozzles, despite maintenance of the permitted tolerances.

It is the principal object of the present invention to provide a spark ignition internal combustion engine with direct fuel injection in which the mixture formation and combustion in the combustion chamber are improved.

### SUMMARY OF THE INVENTION

In an internal combustion engine comprising at least one cylinder including a combustion chamber formed between a piston and a cylinder head which has inlet and exhaust ports, and an outwardly opening injection nozzle for injecting fuel in the form of a hollow cone into the combustion chamber and a spark plug mounted in the cylinder head, the spark plug is positioned at a distance B from the exhaust port axis and the cylinder bore has a diameter D such that the ratio B/D is between 0.02 and 0.13, in particular between 0.04 and 0.1.

With the proposed first ratio a charging motion generated during a charge cycle is adapted to the quantity of fuel injected into the combustion chamber, so that the fuel is distributed uniformly within the hollow fuel cone formed in the combustion chamber. Ignitable mixture components are therefore available in the region of the spark plug electrodes at the time of ignition. The effects surprisingly achieved thereby can be explained by the favorable coordination between an edge swirl formed in the combustion chamber and the bore diameter.

Furthermore, the inventive internal combustion engine is distinguished according to a second exemplary embodiment by the fact that a second ratio of second distance to bore diameter is provided in a range from 0.25 to 0.4, preferably from 0.3 to 0.35. Within the proposed range a controlled movement of the fuel particles along the hollow fuel cone in the direction of the spark plug is ensured, a movement which is adapted to the combustion chamber configuration present. In addition, a sufficiently large contact surface with the combustion air is made available for the fuel droplets swirled in the outer zone of the hollow cone, in dependence on the bore diameter. The present invention provides a concept with which the formation of an ignitable mixture in the vicinity of the spark plug electrodes is optimized, in particular in relation to a jet-guided combustion process.

In a particular embodiment of the invention the spark plug and the fuel injector are positioned such that there is a third distance between an injector axis and a free end portion of the center electrode of the spark plug, a third ratio of third distance to bore diameter being provided in a range from 0.1 to 0.19, in particular from 0.13 to 0.17. The proposed third ratio provides for a distance between the spark plug and a fuel outlet opening in the combustion chamber which is adapted to the cylinder bore, so that a favorable fuel distribution for ensuring reliable ignition is obtained in the combustion chamber.

In a further embodiment of the invention the fuel injector is positioned in the cylinder head such that a fourth distance between a fuel outlet opening and the inlet valve axis is produced, a fourth ratio of a fourth distance to bore diameter being provided in a range from 0.15 to 0.22, in particular from 0.17 to 0.19. With the proposed fourth ratio a notable and rapid fuel propagation, which is adapted to a charging motion and bore diameter, is achieved within the vortex formed. The fuel is therefore mixed rapidly with the combustion air in the outer zones of the edge swirl.

In still a further embodiment of the invention the fuel injector is so positioned in the cylinder head such that a fifth distance is produced between the fuel outlet opening and the exhaust valve axis, such that a fifth ratio of a fifth distance to bore diameter is provided in a range from 0.16 to 0.24, preferably from 0.18 to 0.22. Within the proposed range, according to the invention, flow conditions are generated which are coordinated with the bore diameter and which result in a rapid and sufficient mixing of the fuel droplets with the combustion air in the edge swirl zone.

The invention will become more readily apparent from the following description of exemplary embodiments of the invention on the basis of the accompanying drawings:

### BRIEF DESCRIPTION OF THE DRAWINGS

FIG. 1 is a schematic sectional representation of a cylinder of a direct injection spark ignition internal combustion engine, and

FIG. 2 is an enlarged schematic sectional representation of a combustion chamber of the internal combustion engine according to FIG. 1.

### DESCRIPTION OF PARTICULAR EMBODIMENTS

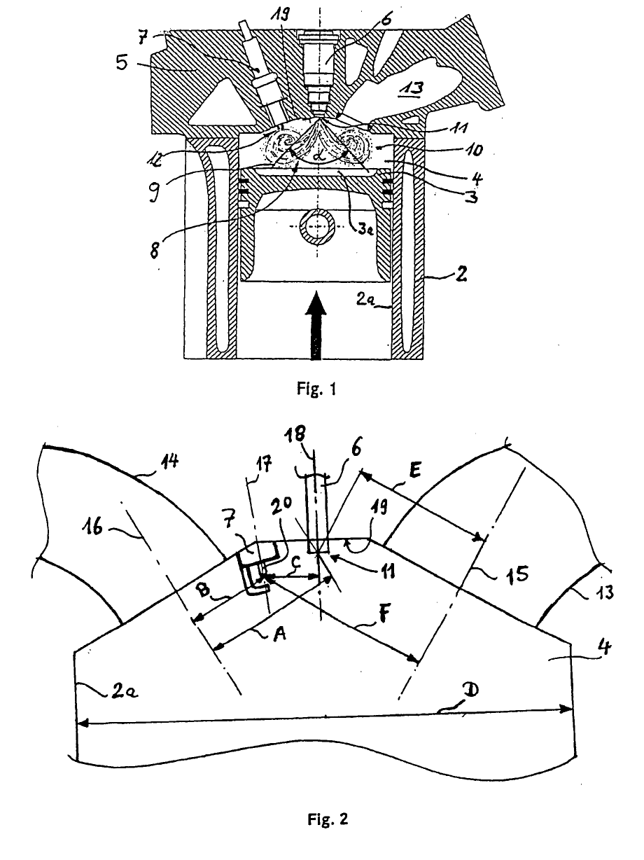

FIG. 1 shows a cylinder 2 of a spark ignition internal combustion engine 1 with direct fuel injection, in which a combustion chamber 4 is delimited between a piston 3 and a cylinder head 5. The internal combustion engine comprises per combustion chamber 4 at least one inlet valve, at least one exhaust valve, a fuel injector 6 and a spark plug 7, the fuel injector 6 and the spark plug 7 being provided adjacent to one another in the central region of a combustion chamber roof 19. A different number of inlet and exhaust valves may be selected within the meaning of the invention. The invention according to the present exemplary embodiment is especially suited to internal combustion engines having two inlet and exhaust valves in each case. Inlet and exhaust ports 13, 14 are provided in the cylinder head 5, a piston recess 3a being preferably provided in the piston 3. The cylinder 2 further comprises a cylinder bore 2a with a bore diameter D.

To achieve optimum ignition conditions in the region of the edge swirl 10 present at the electrodes 12 of the spark plug 7 at the time of ignition, it is necessary to adapt the configuration of the combustion chamber to the jet-guided combustion process. It is therefore the aim of the invention that, by means of an appropriate combustion chamber configuration, ignitable regions of the edge swirl 10 formed are contacted by an ignition spark formed at the spark plug 7 at a time of ignition.

According to the invention the arrangement of the spark plug 7 and of the fuel injector 6 is to be configured in relation to the combustion chamber relationships, and in particular to the cylinder bore 2a. According to FIG. 2 the fuel injector 6 is positioned in the central region of the combustion chamber roof 19 and has an outwardly-opening injection nozzle, a fuel outlet opening 11 of the injection nozzle projecting into the combustion chamber 4. The spark plug 7 is also arranged in the exhaust side of the combustion chamber roof between the exhaust port 16 and the fuel injector 6, although it may also be arranged on the inlet side within the meaning of the invention.

The present invention provides that the arrangement of the spark plug 7 is selected in a manner which is coordinated with the positions of the inlet and exhaust ports relative to the cylinder bore 2a. According to a first exemplary embodiment of the invention, a first ratio B/D of first distance B to bore diameter D is in a range from 0.02 to 0.13, in particular from 0.04 to 0.1. In this case the first distance B corresponds to a shortest distance between a free end portion of the center electrode of the spark plug 7 and a central axis 16 of the exhaust port. With the first ratio B/D the spark plug is positioned in a region in which ignitable mixture components are present at a time of ignition. Misfiring is thereby avoided.

In order to ensure the formation of ignitable fuel/air mixture in the region of the electrodes 12, the invention provides, according to a second exemplary embodiment, that a second ratio F/D of second distance F to bore diameter D is in a range from 0.25 to 0.4, in particular from 0.3 to 0.35. In this case the second distance F corresponds to a shortest distance between the free end portion of the center electrode of the spark plug 7 and a central axis 15 of the inlet valve (not shown). Through the arrangement of the spark plug obtained, transportation of ignitable mixture components in the outer region of the edge swirl 10 is promoted in the direction of the spark plug 7 in coordination with a charging motion formed in the combustion chamber 4.

It is possible for the spark plug 7 to be positioned according to both the first and second exemplary embodiments. The two exemplary embodiments can therefore be combined with one another. A concept is thereby made available with which the formation of ignitable mixture in the vicinity of the electrodes of the spark plug is optimized, especially with regard to the jet-guided combustion process. The effects surprisingly achieved thereby are explained by the favorable coordination between the edge swirl 10 formed and the position of the ignition spark in the combustion chamber in relation to the bore diameter.

In addition, the fuel injector 6 and the spark plug 7 are arranged in the combustion chamber in such a way that a third ratio C/D of third distance C to bore diameter D is in a range from 0.1 to 0.19, in particular from 0.13 to 0.17. The third distance C corresponds to a shortest distance between a fuel injector axis 18 and the free end portion of the spark plug center electrode 20.

To further optimize the combustion chamber configuration, the present invention provides for selection of the arrangement of the fuel injector 6 in a manner coordinated with the positions of the inlet port 15 and the exhaust port 16 relative to the cylinder bore 2a. With the aid of the proposed combustion chamber configuration for minimizing the occurrence of misfiring, therefore, a possible appearance of fuel-poor zones in the electrode region at a time of ignition is avoided. The combustion chamber 4 of the internal combustion engine 1 according to the invention is configured such that a fourth ratio E/D of fourth distance E to bore diameter D is in a range from 0.15 to 0.22, in particular from 0.17 to 0.19. The fourth distance E corresponds to a shortest distance between the fuel outlet opening 11 and the central axis 15 of the inlet port 13. Through the proposed fourth distance E, the quantity of fuel in the outer region of the edge swirl 10 is mixed intensively with the compressed combustion air. Transportation of ignitable mixture into the vicinity of an ignition spark at the spark plug 7 is therefore promoted.

To ensure the formation of ignitable fuel/air mixture in the region of the electrodes 12, the invention further provides a combustion chamber configuration in which a fifth ratio A/D of fifth distance A to bore diameter D is in a range from 0.16 to 0.24, in particular from 0.18 to 0.22. The fifth distance A corresponds to a shortest distance between the fuel outlet opening 11 and the central axis 16 of the exhaust port 14.

According to the invention, the spark plug 7 may be arranged between the inlet port 13 and the fuel injector 6 or between the exhaust port 14 and the fuel injector 6, while maintaining the proposed combustion chamber configuration ratios. Through the ratios provided there is provided a spark plug/fuel injector arrangement which is adapted to the cylinder bore, and with which the formation of ignitable mixture in proximity to the electrodes of the spark plug is ensured.

The internal combustion engine 1 shown in FIG. 1 operates on the four-stroke principle, although, according to the invention, the internal combustion engine may also be configured as a spark ignition two-stroke engine with direct fuel injection. In the first stroke, combustion air is supplied to the combustion chamber 4 through the inlet port 13, the piston 3 moving downwardly to a bottom dead center. In the following compression stroke the piston 3 moves upwardly from a bottom dead center to a top dead center, the fuel being injected in a stratified charge mode of the internal combustion engine 1 during the compression stroke. In the region of top dead center a fuel/air mixture formed is ignited by means of the spark plug 7, the piston 3 being propelled in a downward movement to the bottom dead center. In the last stroke the piston 3 moves upwardly to top dead center and expels the exhaust gases from the combustion chamber 4.

According to the invention, the internal combustion engine 1 is operated in such a way that a stratified charge mode is used in the lower and medium speed and load ranges and a homogeneous charge mode is used in the upper load range. The invention is especially suitable for internal combustion engines with a displacement volume of two to seven liters, preferably from three to six liters. Furthermore, bore diameters from 85 mm to 100 mm are preferred.

A jet-guided combustion process is present in particular in the stratified charge mode. Injection of the fuel takes place with an injection pressure of approximately 60 to 500 bar. In particular in the stratified charge mode, fuel injection takes place with an injection pressure of approximately 180 to 220 bar, preferably 195 to 205 bar at a timing point at which a back-pressure in the combustion chamber at the time of fuel injection is from 8 to 20 bar, preferably from 10 to 16 bar. In the present exemplary embodiment, this corresponds to a crank angle range from 50° to 10° before an upper dead center ignition point. The crank angle range specified here serves only as an example, since, depending on the design and operating mode of the internal combustion engine and on the load point, the back-pressure range or cylinder pressure range proposed according to the invention may lie in a different crank angle range. For example, with pressure-charged internal combustion engines the proposed combustion chamber back-pressure lies altogether within an earlier crank angle range than with non-pressure-charged internal combustion engines.

With the jet-controlled combustion process according to the invention, an outwardly-opening injection nozzle 11 is preferably used, with which a hollow fuel cone 8 with an angle α of from 75° to 100°, preferably from 85° to 95° or from 80° to 90°, is generated. Because the hollow fuel cone 8 impinges on combustion air compressed in the combustion chamber 4, a toroidal edge swirl 10 is formed in the combustion chamber 4, in such a way that an ignitable fuel/air mixture is produced in the region of the electrodes 12 of the spark plug 7. The arrangement of the spark plug 7 is selected such that the electrodes 12 of the spark plug 7 project into the edge swirl 10 produced, whereas during injection of the fuel they are disposed outside a lateral surface 9 of the fuel cone 8. As a result, the electrodes 12 of the spark plug 7 are hardly wetted be fuel. With the ratios implemented, optimum combustion is made possible, in particular in a stratified charge mode, and reliable ignition is achieved at all load points of the internal combustion engine 1.

What is claimed is:

1. An internal combustion engine (1), comprising
at least one cylinder (2) with a cylinder bore (2a) of a given diameter (D), wherein a combustion chamber (4) is formed between a piston (3) and a cylinder head (5), said cylinder head (5) including
at least one air inlet port (13) and at least one exhaust gas outlet port (14),
a fuel injector (6) arranged in the cylinder head (5) which has an outwardly-opening injection nozzle through which fuel is injected into the combustion chamber (4) in the form of a hollow cone (8), and
a spark plug (7) arranged in the cylinder head (5) and projecting into the combustion chamber (4) such that, during the injection of fuel, the electrodes (12) of the spark plug (7) are located outside the injected hollow fuel cone,
the spark plug (7) being positioned in such a way that there is a first distance (B) between an exhaust port axis (16) and a spark plug center electrode (7), whereby
a first ratio (B/D) of the first distance (B) to the cylinder bore diameter (D) is provided in a range of from 0.02 to 0.13.

2. The internal combustion engine (1) according to claim 1, wherein the first ratio B/D is in the range of from 0.04 to 0.1.

3. The internal combustion engine as claimed in claim 1, wherein
the spark plug (7) and the fuel injector (6) are positioned such that there is a third distance (C) between an injector axis (18) and the free end portion of the spark plug center electrode (20), and
a third ratio (C/D) of the third distance (C) to bore diameter (D) being provided in a range from 0.1 to 0.19.

4. the internal combustion engine according to claim 3, wherein the third ratio C/D is from 0.13 to 0.17.

5. The internal combustion engine as claimed in claim 1, wherein
the fuel injector (6) is positioned in the cylinder head (5) such that a fourth distance (E) is provided between a fuel outlet opening (11) and the inlet valve axis (15),
a fourth ratio (E/D) of fourth distance (E) to bore diameter (D) being provided in a range from 0.15 to 0.22.

6. The internal combustion engine as claimed in claim 5, wherein the fourth ratio E/D is from 0.17 to 0.19.

7. The internal combustion engine as claimed in claim 1, wherein
the fuel injector (6) is positioned in the cylinder head (5) such that a fifth distance (A) is produced between the fuel outlet opening (11) and the exhaust valve axis (16),
a fifth ratio (A/D) of fifth distance (A) to bore diameter (D) being provided in a range from 0.16 to 0.24.

8. The internal combustion engine as claimed in claim 6, wherein the fifth ratio A/d is from 0.18 to 0.22.

9. An internal combustion engine (1), comprising
at least one cylinder (2) having a cylinder bore (2a) with a given diameter (D), in which cylinder (2) a combustion chamber (4) is delimited between a piston (3) and a cylinder head (5),
at least one inlet port (13) and at least one exhaust port (14) disposed in the cylinder head (5),
a fuel injector (6) arranged in the cylinder head (5) which has an outwardly-opening injection nozzle through which fuel is injected into the combustion chamber (4) in the form of a hollow cone (8), and
a spark plug (7) arranged in the combustion chamber (4) such that during injection of the fuel the electrodes (12) of the spark plug (7) are located outside the injected hollow fuel cone,
the spark plug (7) being positioned such that a second distance (F) is produced between an inlet valve axis (15) and a free end portion of the spark plug center electrode, and
a second ratio (F/D) of the second distance (F) to the bore diameter (D) is provided in a range from 0.25 to 0.4.

10. An internal combustion engine according to claim 9, wherein the second ratio F/D is from 0.3 to 0.35.

11. An internal combustion engine according to claim 9, wherein
the spark plug (7) and the fuel injector (6) are positioned such that there is a third distance (C) between an injector axis (18) and the free end portion of the spark plug center electrode (20), and
a third ratio (C/D) of the third distance (C) to bore diameter (D) being provided in a range from 0.1 to 0.19.

12. An internal combustion engine according to claim 11, wherein the third ratio C/D is from 0.13 to 0.17.

13. An internal combustion engine according to claim 9, wherein—the fuel injector (6) is positioned in the cylinder head (5) such that a fourth distance (E) is provided between a fuel outlet opening (11) and the inlet valve axis (15),
a fourth ratio (E/D) of fourth distance (E) to bore diameter (D) being provided in a range from 0.15 to 0.22.

14. An internal combustion engine according to claim 13, wherein the fourth ratio E/D is from 0.17 to 0.19.

15. An internal combustion engine according to claim 9, wherein
the fuel injector (6) is positioned in the cylinder head (5) such that a fifth distance (A) is produced between the fuel outlet opening (11) and the exhaust valve axis (16),
a fifth ratio (A/D) of a fifth distance (A) to bore diameter (D) being provided in a range from 0.16 to 0.24.

16. An internal combustion engine according to claim 15, wherein the fifth ratio A/d is from 0.18 to 0.22.
